(19) United States
(12) Patent Application Publication
(10) Pub. No.: US 2014/0262554 A1
(43) Pub. Date: Sep. 18, 2014

(54) Wireless Scale Operation System

(71) Applicant: Carol M. ANDERSON, Dassel, MN (US)

(72) Inventor: Gregory Paul ANDERSON, Dassel, MN (US)

(21) Appl. No.: 14/218,742

(22) Filed: Mar. 18, 2014

Related U.S. Application Data
(60) Provisional application No. 61/802,953, filed on Mar. 18, 2013.

(51) Int. Cl. G01G 19/40

(52) U.S. Cl. CPC G01G 19/40
USPC 177/25.12

(57) ABSTRACT

A system is provided for operating a weighing system and a bulk material handling machinery through a single remote terminal, the terminal being a handheld wireless control unit. The hand held wireless control unit includes a transmitter and receiver which use near field communications to send and receive messages to the weighing system and bulk material handling machinery through a junction box (with its own transmitter and receiver) and control relay (with its own receiver). The junction box can be used to configure the weighing system as well as return data about measured weight recorded by the weighing system. The control relay can pass commands to actuation device that engage mechanisms of the bulk material handling machinery, allowing for remote stopping and starting of the machinery. The system provides improved efficiency by allowing wireless operation of components through a single terminal.

The current application claims a priority to the U.S. Provisional Patent application Ser. No. 61/802,953 filed on Mar. 18, 2013.

### FIELD OF THE INVENTION

The present invention relates generally to a system for remotely interacting with a weighing system and bulk material handling equipment by means of a handheld wireless control unit.

### BACKGROUND OF THE INVENTION

Bulk material handling equipment, such as seed tenders, cranes, trailers, and spreaders, are used across a number of industries. Bulk material handling machinery provides an increase in efficiency, allowing a single person to handle much more material than normal. While such bulk material handling machinery provides a number of advantages, there remains room for improvement.

Currently, there is no product that allows for wireless control of both bulk material handling machinery and weighing systems (e.g. load/offload systems with load cells). Often times, weighing systems must be operated manually at a hardwired panel. This process subtracts from the efficiency of current equipment, as users must either stop a task to manually operate a weighing system, or switch between devices for weighing systems and bulk material handling machinery. For example, when towing a seed tender from a vehicle, some existing solutions require a user must exit the vehicle in order to program the seed tender and scale system. The requirement of manual input via hardwired terminals can result in the loss of valuable work time, especially when handling equipment such as a seed tender must be reset several times in a day. The accumulation of time spent resetting equipment can add up to a significant amount of lost time.

While some existing systems provide wireless interaction with load/unload systems or bulk material handling machinery, there is not an all-in-one solution capable of addressing both functions. The present invention eliminates this inconvenience by allowing all commands, for both a load/offload system and bulk material equipment, to be communicated through near field communications, offering a greater degree of freedom to a user.

It is therefore an object of the present invention to provide a system in which a handheld wireless control unit is capable of unidirectional communication with a control relay and bidirectional communication with a junction box. It is a broader objective of the present invention to provide a wireless all-in-one solution for the operation of a weighing system and a bulk material handling machinery.

### BRIEF DESCRIPTION OF THE DRAWINGS

FIG. 1 is a diagram providing an overview of electrical and communicative connections of the present invention.

FIG. 2 is a diagram illustrating electrical and electronic connections of a handheld wireless control unit of the present invention.

FIG. 3 is an illustration of an example handheld wireless control unit of the present invention.

FIG. 4 is an illustration providing an example of how weight measurements are taken and relayed to the handheld wireless control unit of the present invention.

### DETAIL DESCRIPTIONS OF THE INVENTION

All illustrations of the drawings are for the purpose of describing selected versions of the present invention and are not intended to limit the scope of the present invention.

The present invention is a system for the use of a handheld wireless control unit 1 for the operation of weighing systems 4 and corresponding bulk material handling machinery 5. The present invention provides a single point of operation that allows a user to interact with both the weighing system 4 and the bulk material handling machinery 5. Near field communications allow for interactions to be performed at a distance, improving upon the traditionally utilized hardwired controls and interfaces.

The system of the present invention comprises the handheld wireless control unit 1, the weighing system 4, the bulk material handling machinery 5, a junction box 2, a control relay 3, and a power source 6. These devices are in communication with each other through direct electronic connections or wireless connections; more specifically, the handheld wireless control unit 1 is communicably coupled to both the junction box 2 and the control relay 3, while the junction box 2 is electronically connected to the weighing system 4. Elaborating upon these relations, the handheld wireless control unit 1 and the junction box 2 are engaged in two way communication, whereas the control relay 3 is only capable of receiving transmissions and cannot send responses or initiate communication with the handheld wireless control unit 1. To enable operation of the present invention the power source 6 is electrically connected to the weighing system 4 and the control relay 3, but not the handheld wireless control unit 1 which has its own integrated power unit. Potentially, in an alternative embodiment, the junction box 2 and the control relay 3 (along with their constituent components) can be combined into a single integrated unit. These primary components of the present invention, including their relations and a number of associated constituent components, are illustrated in FIG. 1.

The handheld wireless control unit 1 comprises a remote wireless transmitter 11, a remote wireless receiver 12, an internal power source 13, a remote display 14, a user interface 15, and a processing unit 16. While it is acknowledged that the term transceiver is often used to describe a combined transmitter and receiver, the present invention separates the two terms in the interest of more clearly describing transmission origins and destinations. The internal power source 13 provides power to the components of the handheld wireless control unit 1, being electrically connected to the remote wireless transmitter 11, the remote wireless receiver 12, the remote display 14, the user interface 15, and the processing unit 16. The processing unit 16 supports the operation of the other components and thus is electronically connected to the remote wireless transmitter 11, the remote wireless receiver 12, the remote display 14, and the user interface 15. These electrical and electronic connections are outlined in FIG. 2.

The weighing system 4 comprises a plurality of load cells 41 and a bulk material container 42. The bulk material container 42 serves as storage for various types of bulk material, a common example of which includes seeds as used with tenders. The plurality of load cells 41 are mounted adjacent to the bulk material container 42, allowing them to convert a load of the bulk material container 42 to electrical signals which are transmitted to the junction box 2 for output to a display.

The bulk material handling machinery 5 comprises a plurality of actuation devices 51 which enable several machinery operations. For example, with a seed tender the actuation devices 51 may be used to initiate and cease seed dispensing, increase or decrease the rate of dispensing, and adjust the angle of a feed belt of the seed tender. Such operations, normally carried out via a hardwired interface, are just a few examples of operations which can be enabled through the plurality of actuation devices 51.

The junction box 2 comprises a junction wireless transmitter 21 and a junction wireless receiver 22. The junction wireless transmitter 21 and the junction wireless receiver 22 are supplied with power by an electrical connection to the power source 6 of the present invention. The junction box 2 is electronically connected to the weighing system 4; through this electronic connection, a user can adjust scale settings of the weighing system 4 while the junction box 2 can receive and relay weight readouts and additional relevant information to the other system components.

The control relay 3 comprises a control wireless receiver 31, which is powered by an electrical connection to the power source 6 similar to the transmitter and receiver of the junction box 2. The control relay 3 is provided to pass equipment operation commands from a user to the bulk material handling machinery 5. This capability is a result of the control relay 3 being electronically connected to the bulk material handling machinery 5.

The components of the present invention are able to engage in unidirectional or bidirectional communications with each other, ultimately allowing a user to interact with all the components from a single location. By using the remote wireless transmitter 11 and the remote wireless receiver 12 of the handheld wireless control unit 1, a user is able to configure and receiver data from the weighing system 4 by means of the junction box 2. The user is also able to remotely communicate commands to the bulk material handling machinery 5 through the handheld wireless control unit 1 via the control relay 3, not being tethered by a hardwired connection which is used in current systems. Overall, the present invention provides a single terminal (i.e. the handheld wireless control unit 1) through which a user can control multiple components as related to bulk material handling, specifically a weighing system 4 and a bulk material handling machinery 5. A number of wireless subcomponents, specifically the remote wireless transmitter 11, the remote wireless receiver 12, the junction wireless transmitter 21, the junction wireless receiver 22, and the control wireless receiver 31, allow commands, information, indeed any type of data, to be transmitted through near field communications.

The handheld wireless control unit 1 is able to directly communicate with the junction box 2 and the control relay 3 by means of its remote wireless transmitter 11 and remote wireless receiver 12. The remote wireless transmitter 11 is communicably coupled to the junction wireless receiver 22 and the control wireless receiver 31, allowing commands (e.g. configuring settings or operating equipment) to be sent to the weighing system 4 or the bulk material handling machinery 5. Elaborating upon these connections, the remote wireless transmitter 11 relays commands to the weighing system 4 through the junction wireless receiver 22. This allows for scale settings of the weighing system 4 to be adjusted, such as a configuring a shut-off weight in which a dispensing mechanism of the bulk material handling machinery 5 is sent a shut-off command when the weighing system 4 indicates that the measured weight has dropped below a certain threshold. As the handheld wireless control unit 1 and the junction box 2 are engaged in bidirectional communications, the handheld wireless control unit 1 is able to receive transmissions, in addition to sending them, from the junction box 2 as discussed later.

To expand upon the connection between the handheld wireless control unit 1 and the control relay 3, the remote wireless transmitter 11 relays equipment operation commands to the bulk material handling machinery 5 through the control wireless receiver 31. Through this communications channel equipment operation commands can be relayed to the bulk material handling machinery 5; more specifically, commands can be relayed to the plurality of actuation devices 51. These commands for the actuations devices are used to engage or disengage various mechanisms of the bulk material handling machinery 5 according to a user's instructions or based upon conditional settings. For example, using the previous example of a shut-off command, the remote wireless transmitter 11 sends relays the command through the control wireless receiver 31 to an actuation device for the dispensing mechanism of the bulk material handling equipment which ultimately results in the dispensing mechanism being deactivated. The actuation devices 51 of the bulk material handling machinery 5 are electrical, mechanical, a combination thereof, and potentially additional variations, dependent on the specific bulk material handling machinery 5 being used as part of the present invention. For example, the actuation devices 51 are potentially motors, relays, and valve coils, though they are not limited to said examples. Correspondingly, the mechanisms of the bulk material handling machinery 5 enable a number of functions, examples of which include but are not limited to general operation (e.g. starting and stopping a conveyor of a load/unload system), material dispensing (e.g. as powered by a drive motor), gate management, and tarp configuration. Though current systems usually require such actions to be performed at separate hardwired terminals, the present invention allows such operations and communications to be performed through the all-in-one handheld wireless control unit 1.

As previously mentioned, the handheld wireless control unit 1 is capable of bidirectional communications with the junction box 2. This is supported by the remote wireless receiver 12 being communicably coupled to the junction wireless transmitter 21, allowing the junction box 2 to initiate or respond to communications from the handheld wireless control unit 1. Primarily, this connection enables weight readouts and similar data to be relayed from the weighing system 4 to the handheld wireless control unit 1 through the junction box 2. This data is subsequently output to the remote display 14 of the handheld wireless control unit 1. The user can then obtain relevant information regarding the weighing system 4 via the remote display 14 without having to go to a hardwired terminal or switching between separate terminals provided for the weighing system 4 and the bulk material handling machinery 5. Effectively, the handheld wireless control unit 1 is an suitable substitution or even improvement over existing handheld (e.g. wireless) indicators and hardwired indicators, as currently used. The handheld wireless control unit 1 provides the same capabilities, integrated into an all-in-one solution which can also operate a bulk material handling machinery 5 by means of the control relay 3.

The plurality of load cells 41 of the weighing system 4 are used to measure a weight of bulk material stored in the bulk material container 42, the measured weight then being passed to the junction box 2. The load cells 41 can be implemented in variety of embodiments, most commonly relating the compression due to weight of bulk material to a voltage output of the load cell 41. While only one load cell 41 is required, multiple load cells 41 are desirable as they improve the accuracy of the reported measured weight. Settings or configurations of the load cell 41 can be performed remotely by the aforementioned connection between the remote wireless transmitter 11 and the junction wireless transceiver, with commands input to the handheld wireless transmitter unit being sent to the junction box 2.

A user is capable of operating and interacting with components of the present invention thanks to the remote display 14 and the user interface 15 of the handheld wireless transmitter unit. The remote display 14 allows a user to view received transmissions (e.g. a measured weight readout obtained from the load cells 41) as well as enter conditional actions (such as the aforementioned shut-off command to be sent at an indicated threshold weight). For example, the earlier described relationship between the remote wireless receiver 12 and the junction wireless transmitter 21 entails outputting weighing system data (e.g. weight measurements) to the remote display 14, where a user can easily read the measurements without being physically adjacent to the weighing system 4. Preferably, the user interface 15 comprises a software component which provides menus and pre-set commands that can be displayed on the remote display 14 for improved usability. This software component is electronically connected to the processing unit 16 and the remote display 14, which serve to run the software and provide a visual output, respectively. The user interface 15 is provided to allow a user to enter commands to the handheld wireless control unit 1; the user interface 15 can be provided through a variety of components, a few examples of which include buttons, switches, and even trackball mice. Potentially, the user interface 15 can be integrated into the remote display 14 by means of a capacitive touch screen, allowing the remote display 14 to both output information as well as register user inputs. An example configuration of the handheld wireless control unit 1 is provided in FIG. 3. An example of a measured weight being output to the remote display 14 is shown in FIG. 4.

In one embodiment, the present invention further comprises a scale display 7. The scale display 7 is a hardwired component, being electronically connected to the junction box 2. The scale display 7, similar to the handheld wireless control unit 1, interacts with the weighing system 4 through the junction box 2, allowing scale data such as weight measurements to be output to the scale display 7. This provides a secondary, albeit hardwire rather than wireless, component that enables user interaction with the weighing system 4. The scale display 7, as with other hardwired components, runs thanks to an electrical connection to the power source 6.

An example of applied benefits from the present invention follows. Though the present invention can be utilized with any type of bulk material handling machinery 5, such as cranes, trailers, and spreaders, a seed tender continues to be used in examples for the sake of consistency.

When setting a weight of seeds to be taken from the weighing system 4, a user can scroll through a list of weights displayed on the handheld wireless control unit 1, the list being output to the remote display 14. Potentially, a user could instead directly input the desired weight through the user interface 15, rather than scrolling through the provided list. The handheld wireless control unit 1 can then be used to remotely initiate the seed tender by sending a start-up command from the remote wireless transmitter 11 to the bulk material handling machinery 5 (i.e. seed tender) through the control relay 3. The weight of seeds in the bulk seed container, as measured through the plurality of load cells 41, is then continuously output to the remote display 14, being sent from the junction wireless transmitter 21 to the remote wireless receiver 12. Once the measured weight reaches the entered threshold weight (as indicated via the remote display 14), the handheld wireless transmitter communicates with the control relay 3 to send a shut-off command to an activation device controlling a dispensing mechanism of the bulk material handling machinery 5. Resultantly, the input seed weight will have automatically been dispensed through the present invention; if the bulk material container 42 originally held 50 units of seeds and 30 unites were set to be dispensed, 20 units of seeds would remain in the bulk material container 42 at the end of the dispensing process. As seeds are fed from the bulk material container 42 to the bulk material handling machinery 5, continuous status updates are sent from the weighing system 4 to the handheld wireless control unit 1, originating at the junction wireless transmitter 21 and being output from the remote wireless receiver 12 to the remote display 14. These updates can keep a user informed about numerous factors, such as remaining weight in the bulk material container 42. After initial user configuration, this unloading process is entirely automated and requires no further input from the user, resulting in improved efficiency as a user does not need to switch between different terminals to control different components as required with existing systems.

The user is also able to use the handheld wireless control unit 1 to interact with the seed tender before, during, or after a seed loading process. Inputs can be entered to control to start the seed tender, control the conveyor belt, engage a drive motor, or any additional functions provided by the seed tender and desirable by the user. Thus, the handheld wireless control unit 1 acts as an all-in-one solution that allows a user to operate both a weighing system 4 and a bulk material handling machinery 5 through near field communications, improving upon existing solutions which require a separate terminals (whether hardwired or wireless) for the operation of paired weighing systems 4 and bulk material handling machinery 5.

Although the invention has been explained in relation to its preferred embodiment, it is to be understood that many other possible modifications and variations can be made without departing from the spirit and scope of the invention as hereinafter claimed.

What is claimed is:

1. A wireless scale operation system comprises:
a handheld wireless control unit;
a weighing system;
a bulk material handling machinery;
a junction box;
a control relay;
a power source;
the handheld wireless control unit comprises a remote wireless transmitter and a remote wireless receiver;
the junction box comprises a junction wireless transmitter and a junction wireless receiver;
the control relay comprises a control wireless receiver;
the handheld wireless control unit being communicably coupled to the junction box;
the handheld wireless control unit being communicably coupled to the control relay;
the junction box being electronically connected to the weighing system;
the control relay being electronically connected to the bulk material handling machinery; and
the power source being electrically connected to the weighing system and the control relay.

2. The wireless scale operation system as claimed in claim 1 comprises:
the handheld wireless control unit further comprises an internal power source, a remote display, a user interface, and a processing unit;
the internal power source being electrically connected to the remote wireless transmitter, the remote wireless receiver, the remote display, the user interface, and the processing unit; and
the processing unit being electronically connected to the remote wireless transmitter, the remote wireless receiver, the remote display, and the user interface.

3. The wireless scale operation system as claimed in claim 1 comprises:
the weighing system comprises a plurality of load cells and a bulk material container; and
the plurality of load cells being mounted adjacent to the bulk material container, wherein the bulk material container imparts a force on each of the plurality of load cells.

4. The wireless scale operation system as claimed in claim 3 comprises:
the plurality of load cells being electronically connected to a scale display through the junction box, wherein the weighing system outputs scale data to the scale display; and
the power source being electrically connected to the scale display.

5. The wireless scale operation system as claimed in claim 1 comprises:
the bulk material handling machinery comprises a plurality of actuation devices; and
the control relay being electronically connected to the plurality of actuation devices, wherein equipment operation commands are input to the handheld wireless control unit and relayed to the plurality of actuation devices through the control relay.

6. The wireless scale operation system as claimed in claim 1 comprises:
the remote wireless transmitter being communicably coupled to the junction wireless receiver, wherein the remote wireless transmitter relays commands to the weighing system through the junction wireless receiver; and
the remote wireless receiver being communicably coupled to the junction wireless transmitter, wherein the junction wireless transmitter outputs weighing system data to a remote display through the remote wireless receiver.

7. The wireless scale operation system as claimed in claim 1 comprises:
the remote wireless transmitter being communicably coupled to the control wireless receiver, wherein the remote wireless transmitter relays equipment operation commands to the bulk material handling machinery through the control wireless receiver.

8. A wireless scale operation system comprises:
a handheld wireless control unit;
a weighing system;
a bulk material handling machinery;
a junction box;
a control relay;
a power source;
the handheld wireless control unit comprises a remote wireless transmitter, a remote wireless receiver, an internal power source, a remote display, a user interface, and a processing unit;
the weighing system comprises a plurality of load cells and a bulk material container;
the bulk material handling machinery comprises a plurality of actuation devices;
the junction box comprises a junction wireless transmitter and a junction wireless receiver;
the control relay comprises a control wireless receiver;
the handheld wireless control unit being communicably coupled to the junction box;
the handheld wireless control unit being communicably coupled to the control relay;
the junction box being electronically connected to the weighing system;
the control relay being electronically connected to the bulk material handling machinery; and
the power source being electrically connected to the weighing system and the control relay.

9. The wireless scale operation system as claimed in claim 8 comprises:
the internal power source being electrically connected to the remote wireless transmitter, the remote wireless receiver, the remote display, the user interface, and the processing unit; and
the processing unit being electronically connected to the remote wireless transmitter, the remote wireless receiver, the remote display, and the user interface.

10. The wireless scale operation system as claimed in claim 8 comprises:
the plurality of load cells being mounted adjacent to the bulk material container, wherein the bulk material container imparts a force on each of the plurality of load cells;
the plurality of load cells being electronically connected to a scale display through the junction box, wherein the weighing system outputs scale data to the scale display; and
the power source being electrically connected to the scale display.

11. The wireless scale operation system as claimed in claim 8 comprises:
the control relay being electronically connected to the plurality of actuation devices, wherein equipment operation commands are input to the handheld wireless control unit and relayed to the plurality of actuation devices through the control relay.

12. The wireless scale operation system as claimed in claim 8 comprises:
the remote wireless transmitter being communicably coupled to the junction wireless receiver, wherein the remote wireless transmitter relays commands to the weighing system through the junction wireless receiver; and
the remote wireless receiver being communicably coupled to the junction wireless transmitter, wherein the junction wireless transmitter outputs weighing system data to a remote display through the remote wireless receiver.

13. The wireless scale operation system as claimed in claim 8 comprises:
the remote wireless transmitter being communicably coupled to the control wireless receiver, wherein the remote wireless transmitter relays equipment operation commands to the bulk material handling machinery through the control wireless receiver.

14. A wireless scale operation system comprises:
a handheld wireless control unit;
a weighing system;
a bulk material handling machinery;
a junction box;
a control relay;
a power source;
the handheld wireless control unit comprises a remote wireless transmitter, a remote wireless receiver, an internal power source, a remote display, a user interface, and a processing unit;
the weighing system comprises a plurality of load cells and a bulk material container;
the bulk material handling machinery comprises a plurality of actuation devices;
the junction box comprises a junction wireless transmitter and a junction wireless receiver;
the control relay comprises a control wireless receiver;
the handheld wireless control unit being communicably coupled to the junction box;
the handheld wireless control unit being communicably coupled to the control relay;
the junction box being electronically connected to the weighing system;
the control relay being electronically connected to the bulk material handling machinery;
the remote wireless transmitter being communicably coupled to the junction wireless receiver, wherein the remote wireless transmitter relays commands to the weighing system through the junction wireless receiver;
the remote wireless receiver being communicably coupled to the junction wireless transmitter, wherein the junction wireless transmitter outputs weighing system data to a remote display through the remote wireless receiver;
the remote wireless transmitter being communicably coupled to the control wireless receiver, wherein the remote wireless transmitter relays equipment operation commands to the bulk material handling machinery through the control wireless receiver; and
the power source being electrically connected to the weighing system and the control relay.

15. The wireless scale operation system as claimed in claim 14 comprises:
the internal power source being electrically connected to the remote wireless transmitter, the remote wireless receiver, the remote display, the user interface, and the processing unit; and
the processing unit being electronically connected to the remote wireless transmitter, the remote wireless receiver, the remote display, and the user interface.

16. The wireless scale operation system as claimed in claim 14 comprises:
the plurality of load cells being mounted adjacent to the bulk material container, wherein the bulk material container imparts a force on each of the plurality of load cells;
the plurality of load cells being electronically connected to a scale display through the junction box, wherein the weighing system outputs scale data to the scale display; and
the power source being electrically connected to the scale display.

17. The wireless scale operation system as claimed in claim 14 comprises:
the control relay being electronically connected to the plurality of actuation devices, wherein equipment operation commands are input to the handheld wireless control unit and relayed to the plurality of actuation devices through the control relay.
